(19) United States
(12) Patent Application Publication
(10) Pub. No.: US 2005/0011640 A1
(43) Pub. Date: Jan. 20, 2005

(54) Air conditioner for vehicle

(75) Inventors: Isao Tohda, Hiroshima (JP); Kouji Iwasaka, Hiroshima (JP); Yukio Nakamura, Hiroshima (JP)

Correspondence Address: NIXON PEABODY, LLP, 401 9TH STREET, NW, SUITE 900, WASHINGTON, DC, 20004-2128, US

(73) Assignee: MAZDA MOTOR CORPORATION, Hiroshima (JP)

(21) Appl. No.: 10/863,289

(22) Filed: Jun. 9, 2004

(30) Foreign Application Priority Data
Jul. 17, 2003 (JP) 2003-275783
Jul. 24, 2003 (JP) 2003-279078
Jul. 24, 2003 (JP) 2003-279079

(51) Int. Cl. B60H 3/00; B61D 27/00; B60H 1/00; B60H 1/32

(52) U.S. Cl. 165/202; 165/42; 62/239

(57) ABSTRACT

A rear air conditioning unit is disposed behind a rear bulkhead separating a rear portion of a passenger compartment. The rear air conditioning unit takes in inside-and-outside air for air conditioning via a rear cowl portion disposed above the rear bulkhead head and blows off conditioned air into the passenger compartment. Accordingly, since a layout of an air conditioning unit disposed at the front side of the vehicle is omitted, an engine as a heavy article can be located at the center side of the vehicle and a yaw inertia moment of the vehicle can be reduced, thereby improving maneuverability and stability of the vehicle and dynamic performance of the vehicle. Further, a layout of the rear air conditioning unit and induction of the inside-and-outside air can be made compatible.

### BACKGROUND OF THE INVENTION

The present invention relates to an air conditioner for a vehicle comprising an air conditioning unit to control air conditioning of an inside of a passenger compartment of the vehicle.

Conventionally, the following structure is known as the above-mentioned air conditioner for a vehicle. Namely, it is a so-called twin air-conditioning type of air conditioner for a vehicle in which there is provided at a front side of the vehicle an air conditioning unit including a blower, an evaporator, and a heater core, while there is provided at a rear side of the vehicle a rear cooler unit including a blower and an evaporator (see Japanese Laid-Open Patent Publication No. 5-193337).

In this air conditioner for a vehicle, since the air conditioning unit is disposed at the front side of the vehicle, there are problems that a moved-back layout of a vehicle engine would be prevented and a yaw inertia moment would become large, thereby deteriorating maneuverability and stability of the vehicle and dynamic performance of the vehicle.

Meanwhile, the following structure is known as an air conditioner for a so-called open car. Namely, an air conditioning unit for the open car is placed at a front portion of a vehicle body between a dash lower panel and an instrument panel (see Japanese Laid-Open Patent Publication No. 7-266841).

In this air conditioner of the open car, since the air conditioning unit is disposed at the front side of the vehicle as well, there are the same problems that a moved-back layout of a vehicle engine would be prevented and a yaw inertia moment would become large, thereby deteriorating maneuverability and stability of the vehicle and dynamic performance of the vehicle.

### SUMMARY OF THE INVENTION

The present invention has been devised in view of the above-mentioned problems, and an object of the present invention is to provide an air conditioner for a vehicle that can improve maneuverability and stability of the vehicle and dynamic performance of the vehicle by reducing a yaw inertia moment, and provide compatibleness of a layout of a rear air conditioning unit and an induction of inside-and-outside air.

According to the present invention, there is provided an air conditioner for a vehicle comprising a passenger compartment of the vehicle, a rear bulkhead separating a rear portion of the passenger compartment, a rear cowl portion disposed above the rear bulkhead, and a rear air conditioning unit disposed behind the rear bulkhead, the rear air conditioning unit taking in inside-and-outside air for air conditioning via the rear cowl portion and blowing off conditioned air into the passenger compartment of the vehicle.

According to the above-mentioned structure, since a layout of an air conditioning unit disposed at the front side of the vehicle is omitted, a vehicle engine as a heavy article can be located at the center side of the vehicle and a yaw inertia moment of the vehicle can be reduced, thereby improving the maneuverability and stability of the vehicle and the dynamic performance of the vehicle. Namely, compatibleness of a center layout of the engine and a layout of the air conditioning unit can be provided.

Further, since the rear air conditioning unit takes in the inside-and-outside air for air conditioning via the rear cowl portion and blows off the conditioned air into the passenger compartment of the vehicle, compatibleness of the layout of the rear air conditioning unit and the induction of the inside-and-outside air can be provided.

According to an embodiment of the present invention, an engine room in which an engine of the vehicle is disposed is formed before the passenger compartment of the vehicle. Accordingly, a compact vehicle with a front engine can be provided.

According to another embodiment of the present invention, an upper part of the passenger compartment is covered by a roof capable of opening. Accordingly, a simple structure of the air conditioner for a so-called open car can be provided.

According to another embodiment of the present invention, there are provided an inside-and-outside air induction port formed on an upper side of the rear cowl portion and an aero-board attached near the inside-and-outside air induction port, wherein the aero-board is attached so as to change its position and a positional change of said aero-board provides an induction switching of the inside-and-outside air for air conditioning. Accordingly, a proper switching between an inside-air induction and an outside-air induction can be attained by changing the position of the aero-board.

According to another embodiment of the present invention, there is provided an outside-air induction passage which leads to the rear cowl portion and opens to an outside of the vehicle through a vehicle outside wall. Accordingly, the induction of the outside air through the vehicle outside wall can be ensured.

According to another embodiment of the present invention, there is provided a blowoff port for blowing off the conditioned air from the rear air conditioning unit, which is formed on a side of the rear bulkhead which is located toward an inside of the passenger compartment of the vehicle. This blowoff port may be provided for a neck portion of the passenger sitting on the seat. Accordingly, the distance between the rear air conditioning unit and the blowoff port can be made short, thereby reducing a passage length between them.

According to another embodiment of the present invention, a seat of the vehicle is disposed before and close to the rear bulkhead in the passenger compartment of the vehicle, and the seat has a blowoff port formed thereon for blowing off the conditioned air from the rear air conditioning unit. Accordingly, comfortable air conditioning can be attained by the conditioned air from the blowoff port formed on the seat.

According to another embodiment of the present invention, the blowoff port on the seat is located so as to blow off the conditioned air toward a back portion of a passenger sitting on the seat. Accordingly, since a proper control of air conditioning at the back portion of the passenger is provided, comfortable air conditioning can be attained.

According to another embodiment of the present invention, the blowoff port on the seat is located so as to blow off the conditioned air toward a lumbar portion of a passenger sitting on the seat. Accordingly, since a proper control of air conditioning at the lumber portion of the passenger is provided, comfortable air conditioning can be attained.

According to another embodiment of the present invention, there is provided a tunnel portion extending forward of the vehicle from a lower portion of the rear bulkhead, and the tunnel portion has a blowoff port formed thereon for blowing off the conditioned air from the rear air conditioning unit toward a thigh portion of a passenger. Accordingly, since a proper control of air conditioning at the thigh portion of the passenger is provided with utilizing the tunnel portion, comfortable air conditioning can be attained.

According to another embodiment of the present invention, there is provided a tunnel portion extending forward of the vehicle from a lower portion of the rear bulkhead, and the tunnel portion has a blowoff port formed thereon for blowing off the conditioned air from the rear air conditioning unit toward a foot portion of a passenger. Accordingly, since a proper control of air conditioning at the foot portion of the passenger is provided with utilizing the tunnel portion, comfortable air conditioning can be attained.

According to another embodiment of the present invention, there is provided a tunnel member above the tunnel portion which forms a passage having a closed cross section with the tunnel portion, and an air conditioning duct for the conditioned air from the rear air conditioning unit is formed in the passage having the closed cross section. Accordingly, the air conditioning duct can be provided properly by utilizing the closed cross section between the tunnel portion and the tunnel member formed to increase rigidity of a vehicle floor and a vehicle body.

According to another embodiment of the present invention, the rear air conditioning unit takes in at least inside air of the passenger compartment, conditions the took-in air, and blows off the conditioned air into the passenger compartment, and there is further provided a front natural ventilation unit which is disposed before the passenger compartment, takes in outside air of the vehicle, and blows off the took-in air into the passenger compartment. The front natural ventilation unit is a unit which has no function of temperature controlling and takes in the outside air of the vehicle into the passenger compartment of the vehicle. Accordingly, the rear air conditioning and the natural ventilation can made compatible.

According to another embodiment of the present invention, there is provided air conditioning control means for cooperatively controlling the rear air conditioning unit and the front natural ventilation unit. Accordingly, since the rear air conditioning unit and the front natural ventilation unit are controlled cooperatively by the air conditioning control means, utility of controlling can be improved without controlling them separately.

According to another embodiment of the present invention, there is provided a tunnel portion extending forward of the vehicle from a lower portion of the rear bulkhead, and the tunnel portion has a blowoff port formed thereon for blowing off the outside air of the vehicle from the front natural ventilation unit. Accordingly, a comfortable feeling by the outside air during a vehicle running can be provided to the passenger by utilizing the tunnel portion. Especially, the ventilation by this outside air (natural wind) can be enhanced for the passenger of the open car.

According to another embodiment of the present invention, the rear air conditioning unit is disposed between the rear bulkhead and a trunk room which is disposed behind the rear bulkhead, and there is further provided a trunk-room cooling-air passage for taking in cooling air from the rear air conditioning unit and providing the cooling air into the trunk room to cool an inside of the trunk room. Accordingly, since the rear air conditioning unit is disposed between the rear bulkhead and the trunk room behind the rear bulkhead and the trunk room is cooled by the cooling air from the rear air conditioning unit, forming the trunk room and providing the rear air conditioning unit can be made compatible, and also the trunk room can be cooled by the rear air conditioning unit of the air conditioner for the vehicle, without providing any additional cooling devices for the trunk room. Further, a cooling passage between the rear air conditioning unit and the trunk room can be made short.

According to another embodiment of the present invention, the trunk room is divided into plural load compartments, and the cooling air is introduced into at least one of the load compartments to constitute it as a cooler box. Accordingly, the cooler box can be cooled certainly and efficiently.

According to another embodiment of the present invention, there is provided a suspension damper for suspending a rear wheel of the vehicle close to the trunk room, and the suspension damper is cooled by the cooling air from the rear air conditioning unit. Accordingly, since the cooling air of the rear air conditioning unit cools the suspension damper, durability of the suspension damper can be prevented from deteriorating and the function of the damper can be also prevented from changing due to a heat. Particularly, heat deterioration of oil, a packing, and a rubber in the damper can be prevented.

According to another embodiment of the present invention, there is provided a damper cooling-air passage for taking in the cooling air from the rear air conditioning unit and providing the cooling air to the suspension damper. Accordingly, the damper can be cooled more certainly by the cooling air from the damper cooling-air passage.

According to another embodiment of the present invention, there is provided a suspension damper for suspending a rear wheel of the vehicle behind the rear air conditioning unit, and the suspension damper is cooled via a damper cooling-air passage which is formed for taking in cooling air from the rear air conditioning unit and providing the cooling air to the suspension damper. Accordingly, since the cooling air from the rear air conditioning unit is led to the suspension damper via the damper cooling-air passage and cools the damper (particularly, oil, packing, and rubber in the damper), durability of the suspension damper can be prevented from deteriorating and the function of the damper can be also prevented from changing due to the heat.

Generally, while the vehicle remains parked outside in the daytime, the temperature of an atmosphere around the suspension damper increases to a high one at which the durability of the suspension damper will deteriorate or the damper function will change due to the heat. According to the above-mentioned structure, however, these problems can be solved. Particularly, this should be effective in summer having a high temperature outside.

### BRIEF DESCRIPTION OF THE DRAWINGS

FIG. 1 is a schematic side view of a vehicle equipped with an air conditioner according to the present invention.

FIG. 2 is a plan view of FIG. 1.

FIG. 3 is a sectional view of a major part.

FIG. 4 is an enlarged side view of a major part of FIG. 1.

FIG. 5 is a side view showing an inside-air induction state by a positional change of an aero-board.

FIG. 6 is a side view showing an outside-air induction state by the positional change of the aero-board.

FIG. 7 is a perspective view of a major part of FIG. 4.

FIG. 8 is a side view showing another embodiment of an air conditioner for a vehicle.

FIG. 9 is an enlarged sectional view of a major part taken on line A-A of FIG. 7.

FIG. 10 is a perspective view showing a layout of ducts.

FIG. 11 is a side view of a major part of FIG. 10.

FIG. 12 is a sectional view showing a relationship between a seat back and a duct.

FIG. 13 is a side view showing another embodiment of a layout of ducts.

FIG. 14 is a sectional view showing another embodiment of a structure of a duct layout for the seat back.

FIG. 15 is a plan view of a trunk room in which plural load compartments are partitioned.

FIG. 16 is a plan view of another embodiment of load compartment partition.

FIG. 17 is a sectional view showing a relationship between a suspension damper and a duct.

FIG. 18 is a side view showing a front natural ventilation unit.

FIG. 19 is a perspective view showing the front natural ventilation unit.

FIG. 20 is a perspective view showing another embodiment of the front natural ventilation unit.

FIG. 21 is a perspective view showing another embodiment of a layout of an air conditioning control portion.

### DETAILED DESCRIPTION OF THE INVENTION

Hereinafter, preferred embodiments of the present invention will be described with reference to the accompanying drawings.

An exemplary embodiment will be described in detail referring to the drawings.

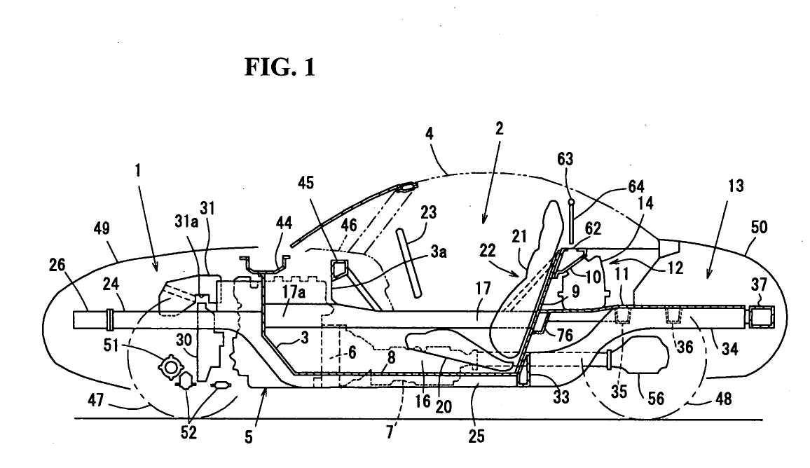

The drawings illustrate an air conditioner for a vehicle. Firstly, a structure of a vehicle body will be described referring to FIGS. 1 through 3. Herein, arrows F, R, IN, and OUT denote respectively a forward direction, a backward direction, an inside direction, and an outside direction of the vehicle in the drawings.

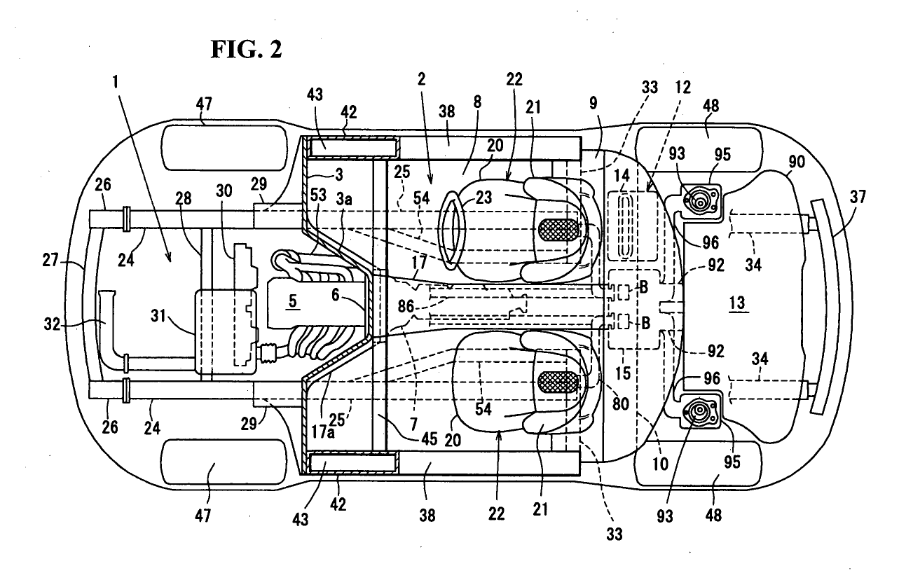

In a side view of FIG. 1 and a plan view of FIG. 2, a dash lower panel 3 (a dash panel) separates a passenger compartment 2 from an engine room 1 in a longitudinal direction of the vehicle. An upper part of the passenger compartment 2 is covered by a roof 4 (a movable roof) which is capable of opening. A central part of the dash lower panel 3 in a width direction of the vehicle is recessed backward to form a recess portion 3a, and an engine 5 is disposed in the recess portion 3a.

The engine 5 is disposed in the longitudinal direction of the vehicle and comprises an ISG unit 6 (Integrated Starter Generator Unit, functioning as both a starter and a generator, which includes a stator and a rotor in a case, in which the rotor is rotated by a drive shaft such as a propeller shaft to produce electric power). Further, a transmission 7 is disposed behind the ISG unit 6 so as to be connected continuously to the ISG unit 6 in a tunnel portion 16 of a floor panel 8.

Further, the floor panel 8 is continuously connected to a lower end portion of the dash lower panel 3 to extend backward in a substantially horizontal direction. A rear bulkhead 9 is provided so as to rise up slantingly from a rear portion of the floor panel 8, at a back face of an upper end portion of which there is provided a rear cowl portion 10 extending in a width direction of the vehicle. Herein, the rear bulkhead 9 is a panel member which separates the passenger compartment 2 from a rear part compartment.

Further, a rear floor 11 is provided so as to extend backward from a middle portion of the rear bulkhead 9 in a vertical direction of the vehicle. A rear air conditioning unit 12 for air-conditioning the passenger compartment 2 is provided near the rear cowl portion 10 on the rear floor 11, and a so-called trunk room 13 (a load compartment) is formed behind the rear air conditioning unit 12. As apparent from FIG. 1, the rear air conditioning unit 12 is disposed within a wheel base of the vehicle.

The rear air conditioning unit 12, as illustrated in FIG. 2, comprises a blower and cooling unit 14, and a heater unit 15. The heater unit 15 is disposed at a central portion in the vehicle width direction, and the blower and cooling unit 14 is disposed at one side of the vehicle in the vehicle width direction.

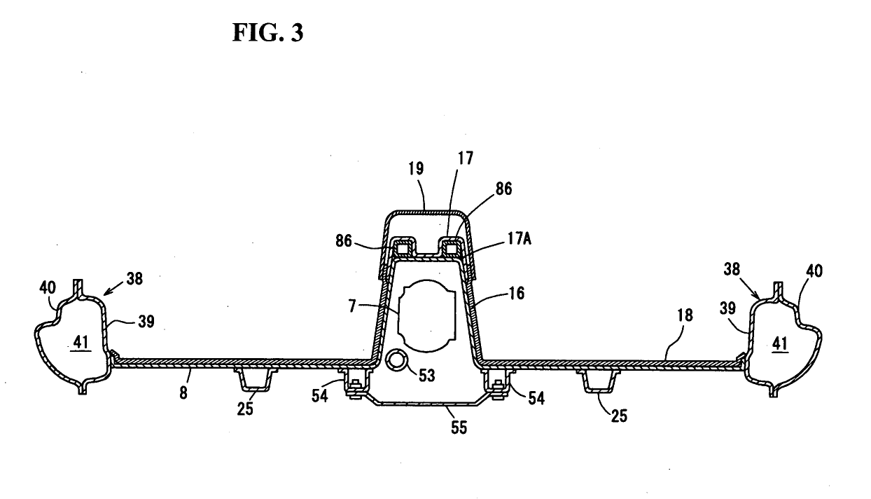

At a central portion of the floor panel 8 constituting a vehicle floor continuously connected to the dash lower panel 3, as shown in FIGS. 1 and 3, there is provided a tunnel portion 16 which protrudes in the passenger compartment 2 and extends in the longitudinal direction of the vehicle. A upper tunnel member 17 (a so-called high-mount-backbone frame) is fixed on an upper portion of the tunnel portion 16 along the tunnel portion 16. The upper tunnel member 17 is connected to the dash lower panel 3 at its front end and to the rear bulkhead 9 at its rear end. Closed cross sections 17A, 17A extending in the longitudinal direction are formed with the upper tunnel member 17 and the tunnel portion 16 as shown in FIG. 3. Thus, the upper tunnel member 17 provides a structure which can improve rigidity of vehicle floor and body.

Herein, as illustrated in FIG. 3, a floor mat 18 is put on the floor panel 8 and the tunnel portion 16, and there is provided a console 19 to cover the upper tunnel member 17 and the tunnel portion 16.

There are provided a pair of left and right seats 22, 22 on the floor panel 8 with the above-mentioned tunnel portion 16 and upper tunnel member 17 between them, which include seat cushions 20, 20 and seat backs 21, 21 respectively. In this embodiment, the right seat 22 corresponding to a steering wheel 23 constitutes a driver's seat, and the left seat 22 constitutes a passenger's seat.

Herein, in the above-mentioned engine room 1, there are provided a pair of left and right front side frames 24, 24, rear ends of which are connected with the dash lower panel 3 and which extend forward in the longitudinal direction from the dash lower panel 3. A kick-up portion of each rear portion of the front side frames 24, 24 is provided along the dash lower panel 3, and there are provided a pair of left and right floor frames 25, 25 which are coupled to respective lower ends of the kick-up portions and extend backward along the floor panel 8.

Connecting members 26, 26 are attached to front ends of the front side frames 24, 24, and a bumper reinforcement 27 is formed to connect the both connecting members 26, 26 and extends in the vehicle width direction.

Further, there is provided a front cross member 28 interconnecting the front side frames 24, 24 and extending in the vehicle width direction. There are provided a pair of batteries 29, 29 just before a normal cross section of the dash lower panel 3 beside the engine 5, which are attached on the front side frames 24, 24.

The butteries 29, 29 also function to charge an electric energy generated by the ISG unit 6 therein, which are placed on conjunction portions of the front side frames 24, 24 with dash lower panel in the present embodiment. Herein, front ends of the batteries 29, 29 are so located before the engine 5 as to receive a load caused by a head-on collision of the vehicle, thereby preventing the engine 5 from moving back.

Extensions 17a, 17a of the upper tunnel member 17 are connected to buttery-disposed portions of the dash lower panel 3 as shown in FIG. 2 so as to convey the collision load properly to the vehicle body.

Further, as shown in FIGS. 1 and 2, a radiator 30 is disposed between the batteries 29, 29 in the engine room 1 so as to overlap with the batteries 29, 29 in the longitudinal direction of the vehicle.

Further, heavy articles such as the driving device including the engine 5 and the ISG unit 6, and auxiliary parts of the batteries 29, 29 and the radiator 30 are all disposed, as shown in FIGS. 1 and 2, within the wheel base in order to reduce yaw inertia moments thereof.

Also, as shown in FIG. 1, there is provided an air cleaner 31 including a recess portion 31a at the bottom, and an upper tank of the radiator 30 is disposed so close to the recess portion 31a that the air cleaner 31 overlaps with the radiator 30 in the vertical direction and the longitudinal direction of the vehicle. The air cleaner 31 is coupled to a L-shaped intake pipe 32, when viewed in a plan view, at its upstream end as shown in FIG. 2.

Herein, as illustrated in FIGS. 1 and 2, rear cross members 33, 33 extending in the vehicle width direction are disposed at rear portions of the floor frames 25, 25 which are fixed to a lower face of the floor panel 8.

A pair of left and right rear side frames 34, 34 are provided so as to extend under the rear floor 11 from back faces of the rear cross members 33, 33. Two rear cross members 35, 36 extending in the vehicle width direction are provided so as to be interposed between the rear side frames 34, 34 and apart from each other in the longitudinal direction. Further, a rear bumper reinforcement 37 extending in the width direction is provided at rear portions of the rear side frames 34, 34.

As shown in FIGS. 2 and 3, there are provided a pair of side sills 38, 38 at both left-and-right ends of the floor panel 8, which extend in the longitudinal direction in parallel to the floor frames 25, 25. Each of the side sills 34, 34, as shown in FIG. 3, is comprised of a side sill inner 39 and a side sill outer 40 to form a vehicle-body rigidity member with a side sill closed cross section 41 extending in the longitudinal direction of the vehicle. Herein, a side sill reinforcement may be provided in the side sill closed section 41 at need.

The side sills 38, 38 are connected to lower ends of hinge pillars 42, 42 extending vertically at their front ends respectively as shown in FIG. 2. Each of the hinge pillars 42, 42 is comprised of a hinge pillar inner and a hinge pillar outer to form a vehicle-body rigidity member with a closed cross section 43 extending in the vertical direction.

There is provided a cowl upper panel 44 that is disposed above the dash lower panel 3 so as to extend in the vehicle direction. There is also provided an instrument panel member 45 with a closed cross section that is located backward away from a front cowl portion including the cowl upper panel 44 so as to extend in the vehicle width direction above the dash lower panel 3. The instrument panel member 45 is connected with rear portions of the hinge pillars 42, 42 at its both left-and right ends, as shown in FIG. 2. The instrument panel member 45 supports an instrument panel 46.

Further, as shown in FIGS. 1 and 2, the above-mentioned recess portion 3a is formed in such manner that the central portion of the dash lower panel 3 in the vehicle width direction is recessed backward from the front cowl portion to the instrument panel member 45. Herein, the above-mentioned pair of extensions 17a, 17a are formed to be integral with the upper tunnel member 17 fixed on the tunnel portion 16, which extend forward along side faces of the recess portion 3a of the dash lower panel 3 to a base face (non-recessed face).

Herein, in FIGS. 1 through 3, a reference numeral 47 denotes a front wheel, and other reference numerals denote respective pars as follows: a rear wheel 48; hood 49; a trunk lid 50; a steering rack 51; a front suspension cross member 52; an exhaust pipe 53; a lower tunnel member 54 extending in substantially parallel with the floor frame 25 in the longitudinal direction; a lower connecting member 55 interconnecting detachably the lower tunnel members 54, 54; and a rear differential device 56.

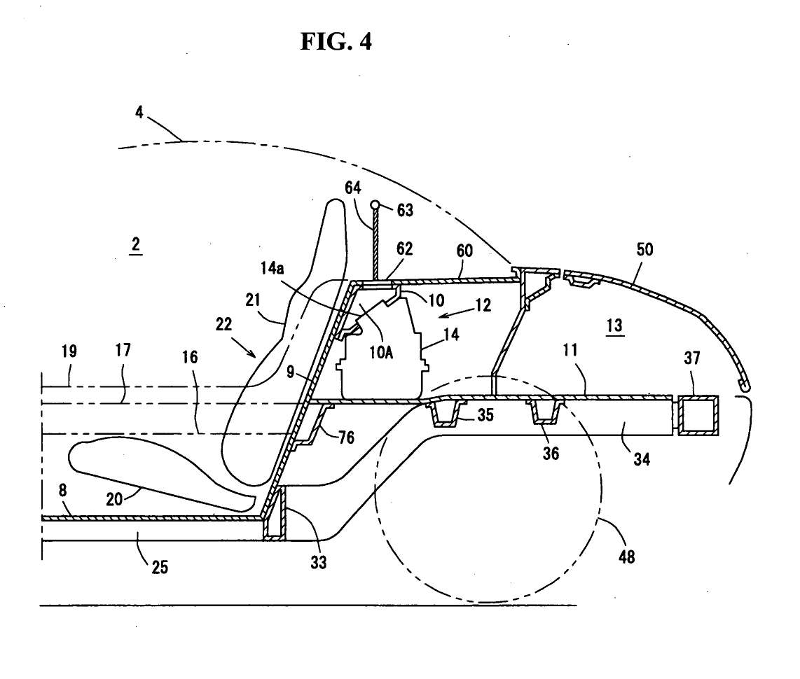

Next, an induction structure for inside and outside air of the air conditioner for the vehicle will be described referring to FIGS. 4 through 7. There is provided a rear package 60 extending substantially horizontally from an upper end of the rear bulkhead 9, and the above-mentioned rear cowl portion 10 is located in the corner between the rear package 60 and the rear bulkhead 9.

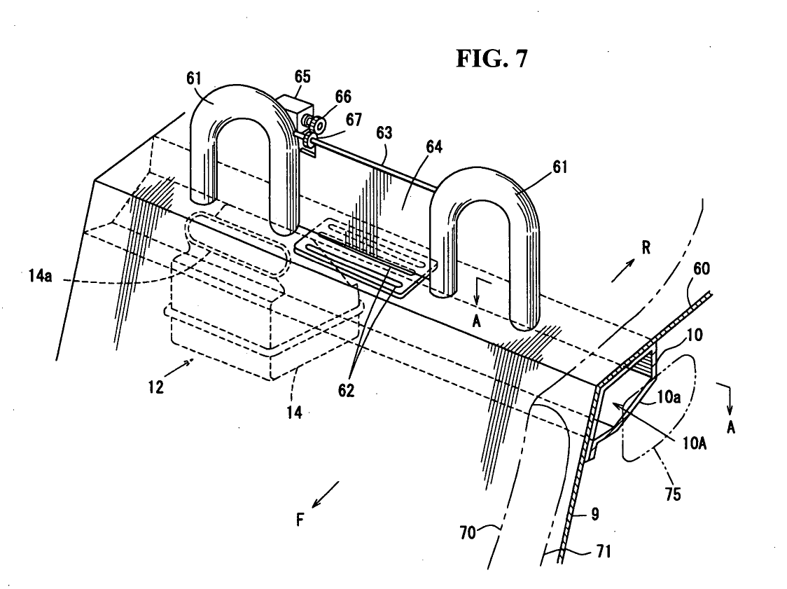

Further, as illustrated in FIG. 7, roll bars 61, 61 are provided on the rear package 60 so as to correspond to the left and right seats 22, 22 in order to protect the passengers, between which there is formed an inside-and-outside air induction port 62 which is integral with the rear package 60 and the rear cowl portion 10 as illustrated in FIGS. 4 through 6.

The above-mentioned blower and cooling unit 14 is configured to take in the inside and outside air from its intake port 14a via the inside-and-outside air induction port 62 and the closed cross section 10A of the rear cowl portion 10.

As shown in FIG. 7, there is provided a supporting shaft 63 on and between upper portions of the roll bars 61, 61 so as to rotate around its shaft axis. An aero-board 64 is attached to the supporting shaft 63, and a lower end of the aero-board 64 extends close to the inside-and-outside air induction port 62 formed on the rear cowl portion 10.

A rotary actuator 65, such as, for example, a DC motor, is mounted on a back face of one of the roll bars 61, 61 directly or via a bracket (not illustrated). A drive gear 66 fixed to a rotational shaft of the actuator 65 and a driven gear 67 connected with the above-mentioned supporting shaft 63 are engaged with each other all the time, and thereby the aero-board 64 is changed in its position by the rotary actuator 65 via respective parts 66, 67, 63.

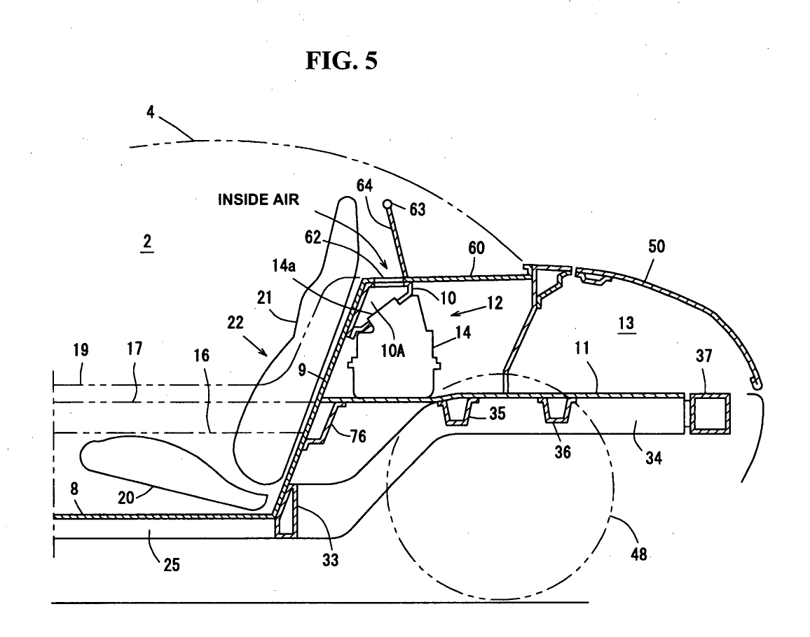

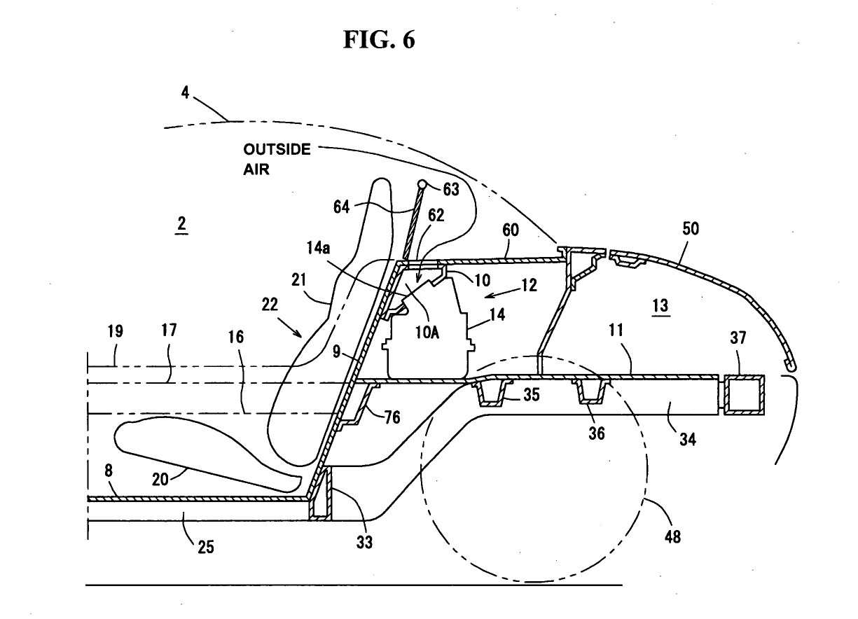

Namely, when the aero-board 64 is located in its neutral position as shown in FIG. 4, the inside-and-outside air induction port 62 takes in the inside air and the outside air. Meanwhile, when the lower end of the aero-board 64 is located backward as shown in FIG. 5, the inside-and-outside air induction port 62 takes in the inside air. Further, when the lower end of the aero-board 64 is located forward as shown in FIG. 6, the inside-and-outside air induction port 62 takes in the outside air (rolled-in wind) due to a negative pressure occurring behind the aero-board 64. Namely, the positional change (change of its slant angle) of the aero-board 64 provides the induction switching of the inside-and-outside air.

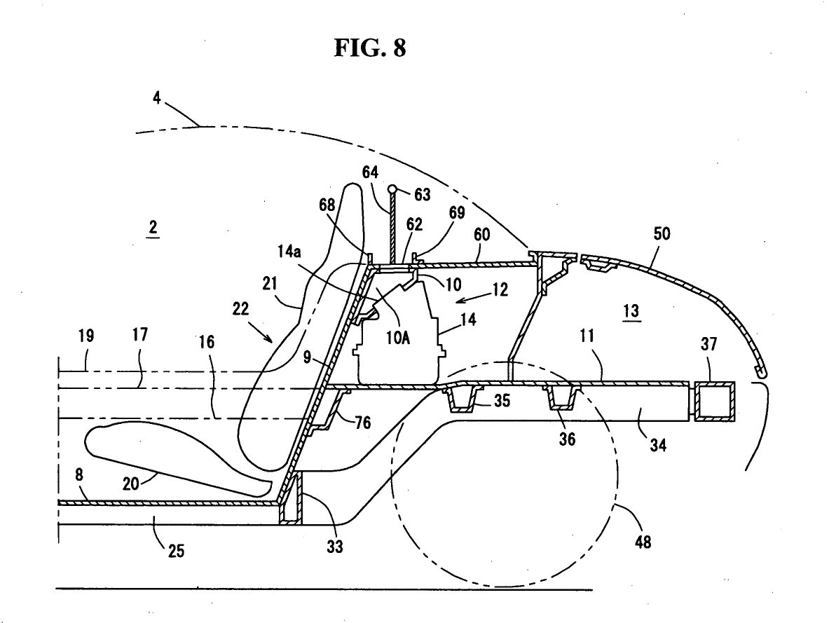

Herein, as shown in FIG. 8, there may be provided limitation members 68, 69 such as stoppers to limit an overrun of the aero-board 64 before and behind the inside-and-outside air induction port 62, aiming at simplifying a control of the rotary actuator 65 such as the DC motor.

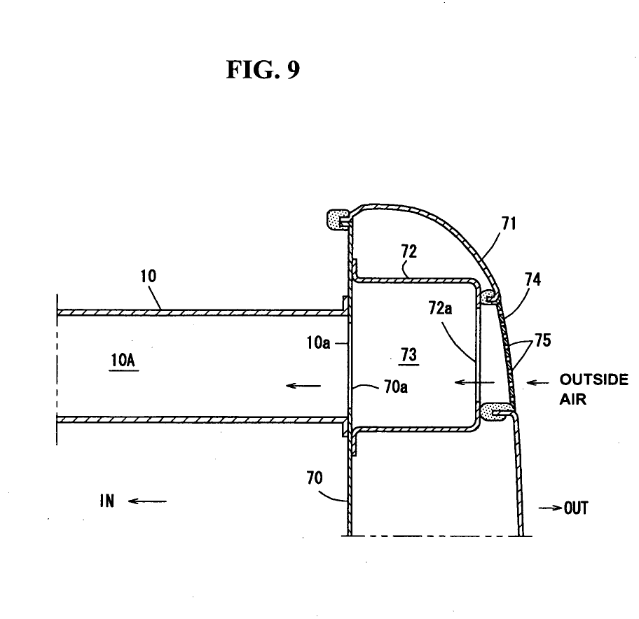

FIG. 9 is a sectional view of a major part taken on line A-A of FIG. 7, in which an inner panel 70 is attached at an end portion of the rear cowl portion 10, and a rear fender panel 71 is provided outside the inner panel 70 which constitutes a vehicle outside wall of the vehicle body. Further, a beltline reinforcement 72 is attached to an inside face of the rear fender panel 71 of the inner panel 70.

There is also provided an outside-air induction passage 73 which leads to the rear cowl portion 10 and opens to an outside of the vehicle through the rear fender panel 71 as the vehicle outside wall. This outside-air induction passage 73 is formed by connecting an outside-air induction port 75 formed on the rear fender panel 71 with a mesh member 74 disposed its opening portion, an opening portion 72a of the beltline reinforcement 72, an opening portion of the inner panel 70, and an opening portion 10a at the side of the rear cowl portion 10 in the vehicle width direction. Herein, in FIGS. 4 through 6, a reference numeral 76 denotes a cross member which is formed in the corner between a lower face of a front portion of the rear floor 11 and a back face of a middle portion of the rear bulkhead 9.

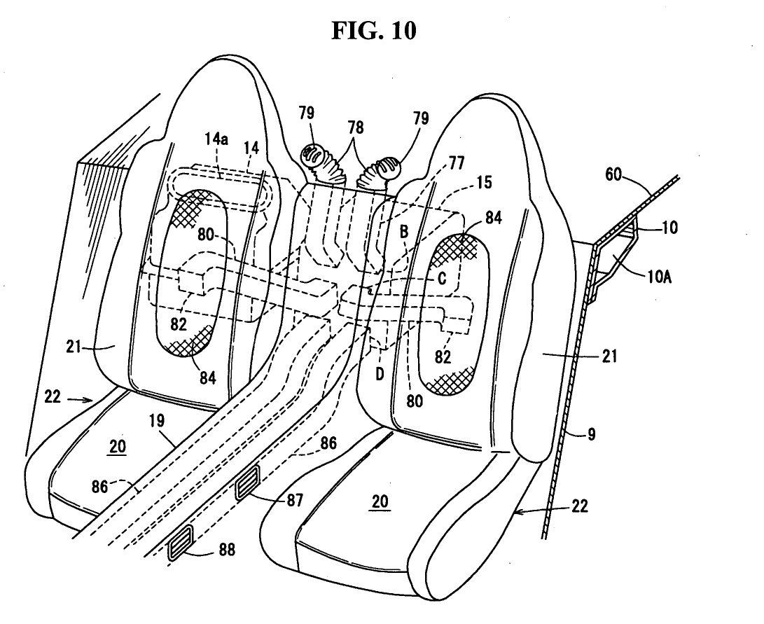

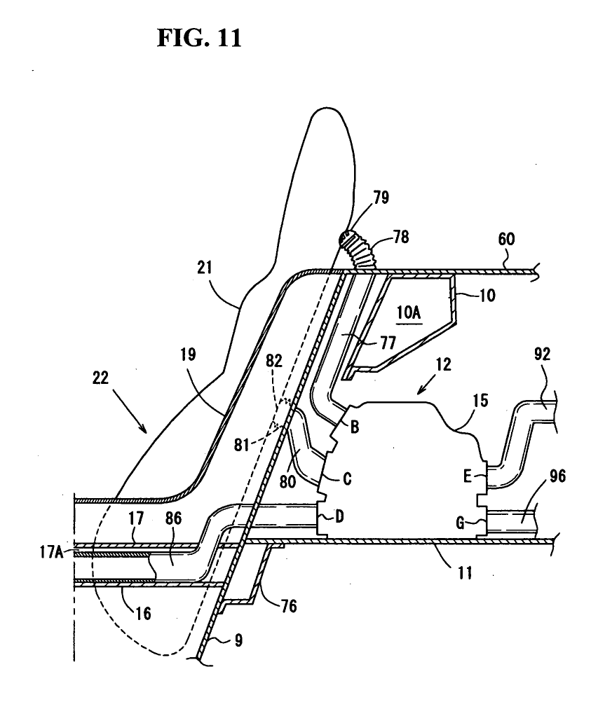

Next, a blowoff passage for conditioned air (warm air) such as cooling air from the heater unit 15 will be described referring to FIGS. 2, 10 and 11. The heater unit 15 comprises a pair of blowoff portions B, C, D, E, and G as illustrated in FIGS. 10 and 11. Meanwhile, the passenger seats 22, 22 (particularly, the seat backs 21, 21) are disposed before and close to the rear bulkhead 9.

A duct 77 is coupled to the blowoff portion B of the heater unit 15, and a blowoff port 79 is formed at a front end of a bellows portion 78 disposed at an upper end of the duct 77 extending upward. Thereby, this blowoff port 79 is located inside the rear bulkhead 9 so that the conditioned air from the rear air conditioning unit 12 is directed to a neck portion of the passenger. The above-mentioned bellows member 78 allows the position and direction of the blowoff port 79 to be adjustable according to needs or physical features of passengers.

Further, a duct 80 is coupled to the blowoff portion C of the heater unit 15, and a blowoff port 82 is formed at a front end of a bellows portion 81 disposed at an upper end of the duct 80 extending upward slightly. Thereby, this blowoff port 82 is attached to the seat back 21 so that the conditioned air from the rear air conditioning unit 12 is directed to a back portion and/or a lumber portion of the passenger sitting on the set 22. The above-mentioned bellows member 78 allows the position and direction of the blowoff port 79 to be adjustable according to needs or physical features of passengers.

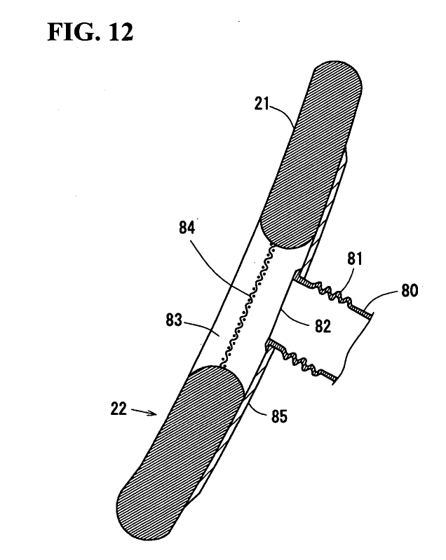

As shown in FIG. 12, a penetrating hole 83 is formed at the middle portion of the seat back 21 so as to penetrate through the seat back, and a net member 84 is disposed at the middle portion of the penetrating hole 83 in the longitudinal direction of the vehicle so as to cover a whole part of the penetrating hole 83.

Also, an edge of the blowoff port 82 is attached to a back face portion of the seat back 21 via an attaching member 85. Thereby, when the passenger leans on the seat back 21, the blowoff port 82 is prevented from being closed. Accordingly, the conditioned air can be properly provided to the back portion and/or lumber potion of the passenger, and there is provided a structure which is available to a forward and backward slide of the seat 22 and a reclining of the seat back 21 by means of the bellows portion 81.

Further, as shown in FIGS. 10 and 11, a duct 86 is coupled to the blowoff port D of the heater unit 15, which is led into the closed cross section 17A formed with the upper tunnel member 17 and the tunnel portion 16 extending forward from the lower portion of the rear bulkhead 9 so as to extend forward. There are also provided a blowoff port 87 which blows off the conditioned air from the rear air conditioning unit 12 toward a thigh portion of the passenger and a blowoff port 88 which blows off the one toward a foot portion of the passenger as well. The blowoff ports 87, 88 are coupled to the duct 86 via the console 19 and the upper tunnel member 17, and there are provided movable louvers at the respective blowoff ports 87, 88.

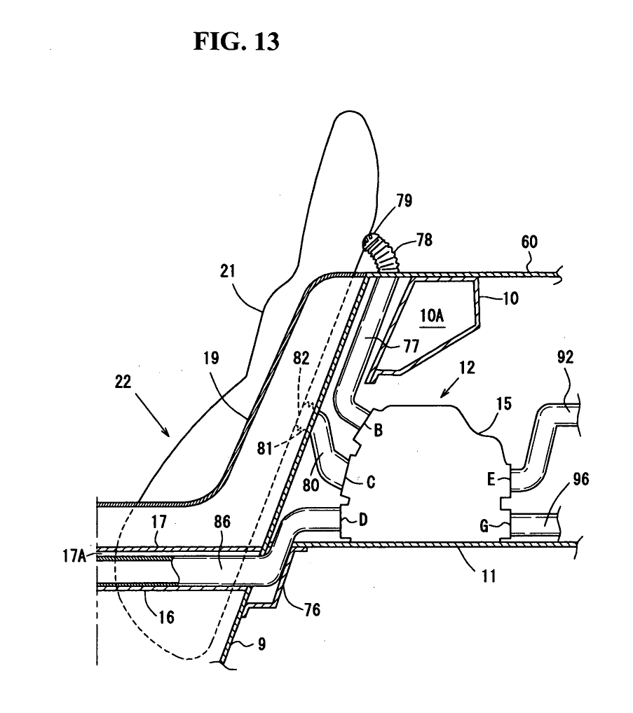

Herein, the duct 86 may be led into the closed cross section 17A via an opening of the rear bulkhead 9 and an opening of the upper tunnel member 17 as shown in FIG. 11, or as shown in FIG. 13, it may be led into the closed cross section 17A via an opening of the rear floor 11, the closed cross section of the cross member 76 and an opening of the rear bulkhead 9.

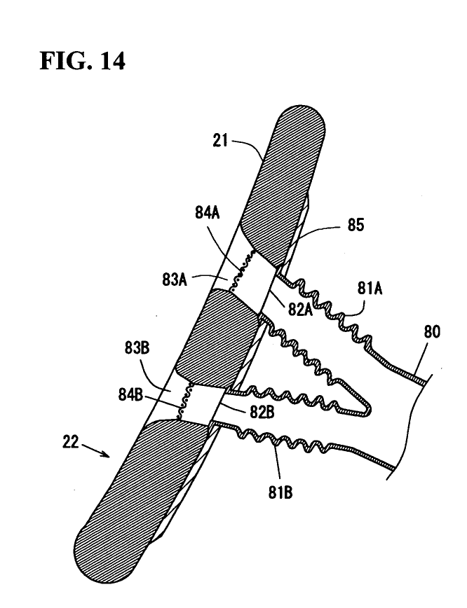

Further, a structure illustrated in FIG. 14 may be used instead of the structure illustrated in FIG. 12. Namely, the duct 80 coupled to the blowoff port C of the heater unit 15 is bifurcated at its fore ends, and blowoff ports 82A, 82B are formed respectively at the both ends via bellows portions 81A, 81B. At the middle portion of the seat back 21, penetrating holes 83A, 83B are formed independently to penetrate through the seat back and be away from each other in the vertical direction. Further, net members 84A, 84B are respectively disposed at the middle portions of the penetrating holes 83A, 83B to cover the holes. Accordingly, the conditioned air blown off from the upper blowoff port 82A may be directed toward the back portion of the passenger, and the conditioned air blown off from the lower blowoff port 82B may be directed toward the lumber portion of the passenger.

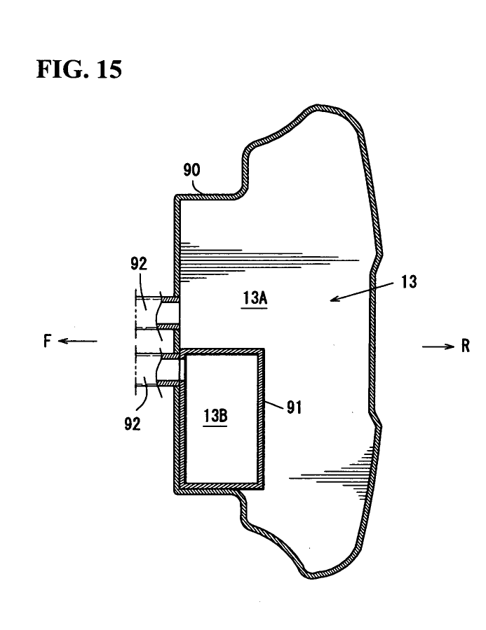

The trunk room 13 enclosed by a trunk trim 90, as illustrated in FIG. 15, is divided into plural load compartments 13A, 13B, and a smaller load compartment 13B is designed as a cooler box 91. An upper opening of the cooler box 91 is covered by a cooler box lid capable of opening (not illustrated).

The above-mentioned rear air conditioning unit 12 is disposed between the rear bulkhead 9 which separates the rear portion of the passenger compartment and the trunk room 13 which is disposed behind the rear bulkhead. A pair of ducts 92, 92 are coupled to the blowoff port E of the heater unit 15 illustrated in FIGS. 11 and 13, which constitutes a cooling air passage to lead the cooling air into the trunk room 13 and cool it, as shown in FIGS. 11, 13 and 15. Particularly, the cooling air is took into the load compartment 13B which is configured as the cooler box 91.

Although it is provided to the divided load compartments 13A, 13B respectively via the ducts 92, 92 in this embodiment, the cooling air may be, off course, provided to only the load compartment 13B of the cooler box 91. Further, although the trunk room 13 is divided into the two load compartments 13A, 13B in this embodiment, more load compartments than two may be also formed in the trunk 13.

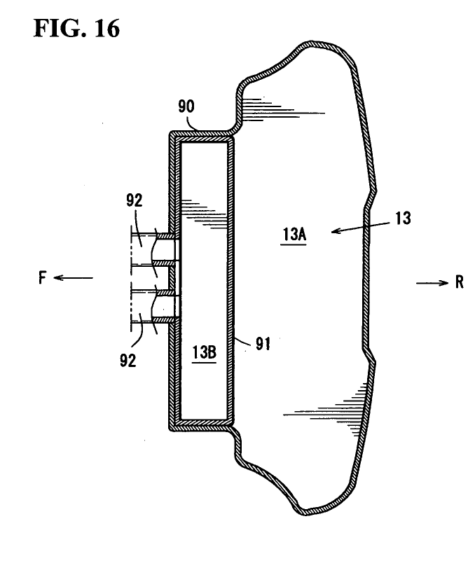

Further, as shown in FIG. 16, the trunk room 13 may be divided into the front load compartment 13B and the rear load compartment 13A which are separated from each other in the longitudinal direction and extend in the vehicle width direction, and the front load compartment 13B may be designed as the cooler box 19 by coupling the pair of ducts 92, 92 thereto.

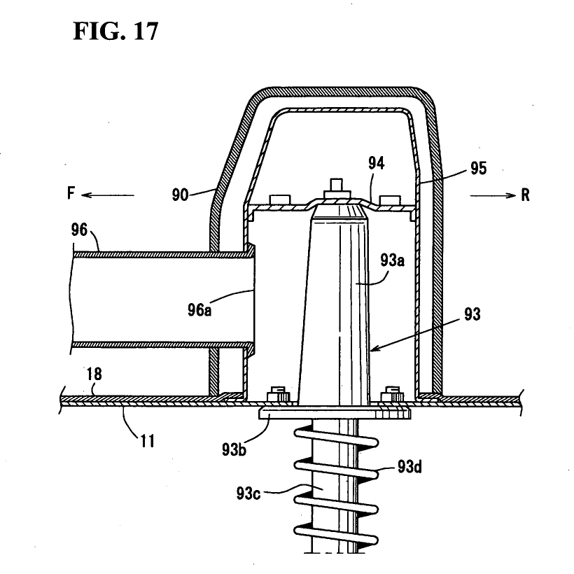

Herein, there is a suspension damper 93 for supporting the rear wheel 48 of the vehicle near the trunk room 13 as illustrated in FIGS. 2 and 17. The suspension damper 93 comprises a damper support 93a, an upper spring seat 93b, a strut 93c, a coil spring 93d and so on. The upper spring seat 93b is supported by the rear floor 11 or a suspension housing (not illustrated), and an upper end portion of the damper support 93a is supported on a suspension tower 95 via a bracket 94. The suspension damper 93 includes oil and rubber members therein.

Also, a pair of ducts 96, 96 are coupled to the blowoff port G of the heater unit 15 illustrated in FIGS. 11 and 13, which constitutes a cooling air passage to lead the cooling air from the rear air conditioning unit 12 to the left and right suspension dampers 93, 93, as shown in FIGS. 2, 11, 13 and 17. Accordingly, the respective suspension dampers 93, 93 can be cooled by the cooling air from the rear air conditioning unit 12.

In this embodiment, a front end opening portion 96a of each of the above-mentioned ducts 96, 96 is connected to the suspension tower 95 via the trunk trim 90 as shown in FIGS. 2 and 17. Accordingly, the suspension damper 93, particularly the oil and rubber members therein are cooled through an inside space of the suspension tower 95, thereby preventing durability of the suspension damper 93 from deteriorating and functions of the damper from changing due to a heat.

While the vehicle remains parked outside in the daytime, the temperature of an atmosphere around the suspension damper 93 increases to a high one at which the durability of the suspension damper 93 deteriorates or the damper function changes due to the heat. However, these problems can be solved by cooling the suspension damper 93 by the cooling air from the duct 96 as the damper cooling air passage.

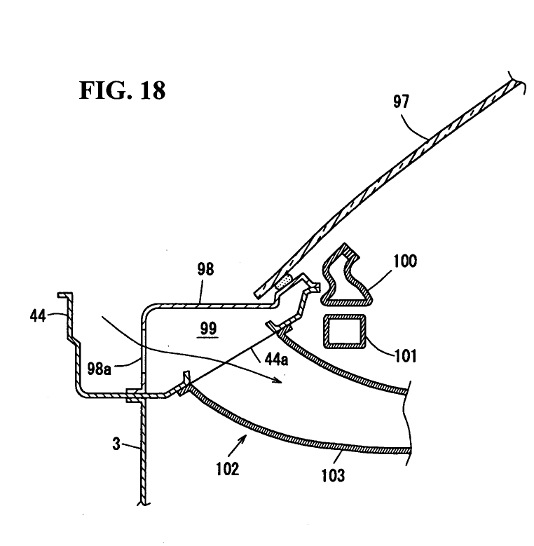

As shown in FIG. 18, the cowl upper panel 44 disposed above the dash lower panel 3 is coupled to a front cowl panel 98 to support a front end of a windshield 97.

The front cowl upper panel 98 includes a substantially L-shaped cross section and extends in the vehicle width direction, and a cowl closed cross section 99 is formed between the front cowl panel 98 and the cowl upper panel 44.

There are provide opening portions 98a, 44a for the front natural ventilation which are formed at a vertical portion of the above-mentioned front cowl panel 98 and the cowl upper panel 44 respectively which correspond to the cowl closed cross section 99.

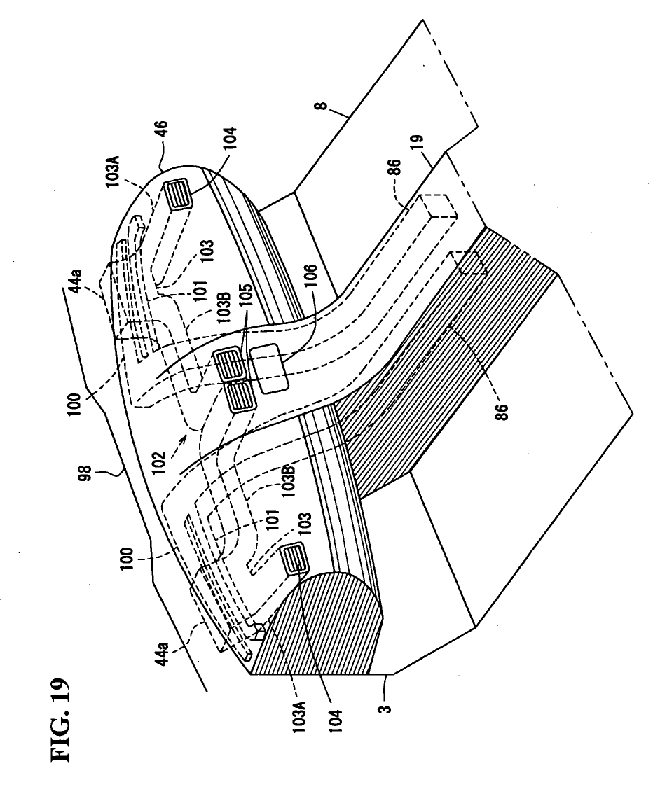

Meanwhile, the pair of ducts 86, 86 illustrated in FIG. 10 extend forward in the closed cross section 17A, 17A between the tunnel portion 16 and the upper tunnel member 17 to a portion near a slant lower end of the windshield 97 in the instrument panel 46 as illustrated in FIG. 19. Front ends of these extended ducts are connected to a pair of left-and-right front defroster ducts 100, 100 and a pair of left-and-right side defroster ducts 101, 101 to provide a constitution of an anti-blur of the windshield. Herein, the ducts 100, 100 and 101, 101 are formed so as to extend in the vehicle width direction from the above-mentioned extended ducts.

Further, as illustrated in FIG. 19, there is provided a front natural ventilation unit 102 which is disposed in the instrument panel 46 before the passenger compartment to take in the outside air and blow off the outside air into the passenger compartment 2.

The front natural ventilation unit 102 comprises bifurcated and symmetrical ducts 103, 103 which are coupled to the above-mentioned opening portions 44a, 44a illustrated in FIG. 18. Each side duct 103A constituting one of the ducts 103, 103 is provided with a side vent blowoff port 104 which is located at a side end of the instrument panel 46. Each center duct 103B constituting the other of the ducts 103, 103 is provided with a center vent blowoff port 105 which is located at the center of the instrument panel 46. These blowoff ports 104,104, 105, 105 are formed on an outer surface of the instrument panel 46.

Namely, as illustrated by an arrow in FIG. 18, the outside air is took in from the opening portion 98a of the front cowl panel 98, the cowl closed cross section 99, and the opening portion 44a of the cowl upper panel 44 into the pair of ducts for the natural ventilation, and the outside air is blown off into the passenger compartment 2 via the side vent blowoff ports 104, 104 and the center vent blowoff ports 105, 105.

There is provided an air conditioning control portion 106, as shown in FIG. 19, at the console 19 below the center vent blowoff portions 105, 105, which is located at one position and functions as control means for cooperatively controlling the rear air conditioning unit 12 and the front natural ventilation unit 10. The air conditioning control portion 106 includes plural switches, CPU and so on which are not illustrated herein for convenience.

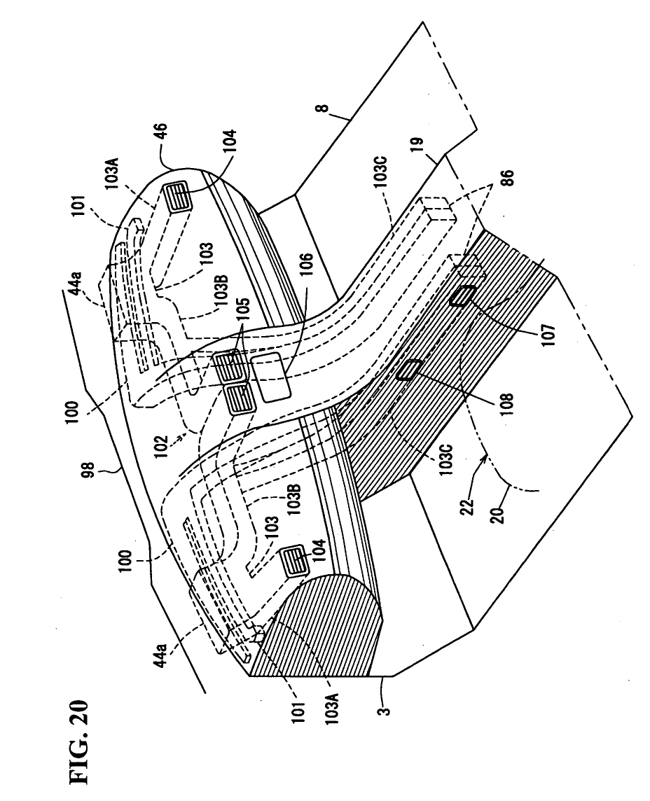

An alternative structure of the front natural ventilation unit 102 shown in FIG. 20 may be used instead of the one shown in FIG. 19. The front natural ventilation unit 102 shown in FIG. 20 are additionally provided with a pair of tunnel ducts 103C, 103C bifurcated from the center ducts 103B, 103B which are disposed in the closed cross sections 17A, 17A between the tunnel portion 16 and the upper tunnel member 17.

The tunnel duct 103C is located outside the duct 86 which is disposed similarly in the closed cross section 17A, and includes a blowoff port 107 to blow off the outside air toward the thigh portion of the passenger and a blowoff port 108 to blow off the one toward the foot portion of the passenger which are took into the tunnel duct 103C from the front natural ventilation unit 102, thereby improving a comfortable ventilation for the passenger by utilizing the outside air of the vehicle.

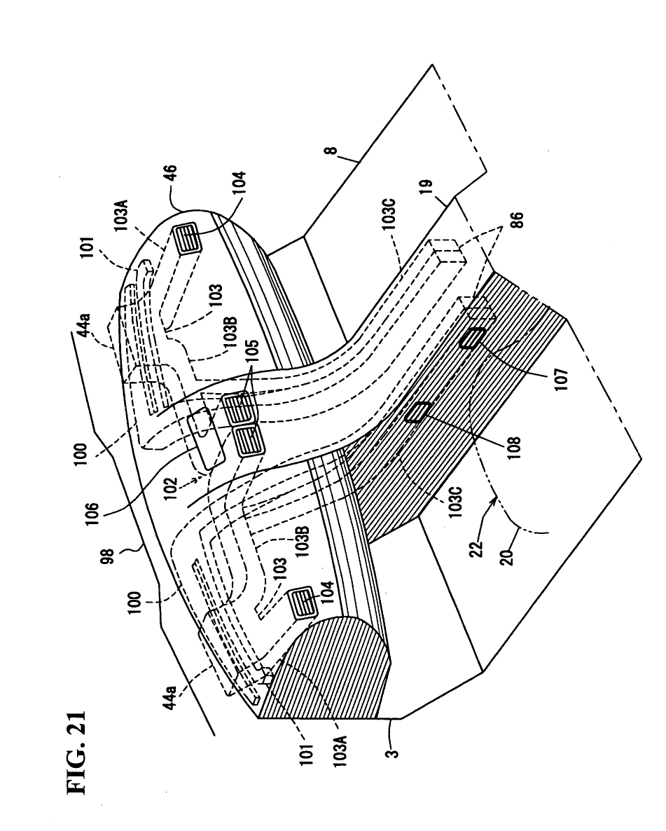

Herein, preferably, the blowoff ports 107, 108 may be coupled to the tunnel duct 103C via the console 19 and the upper tunnel member 17, and the tunnel duct 103C may terminate at downstream of the blowoff port 107. Further, the above-mentioned air conditioning control portion 106 may be disposed, as illustrated in FIG. 21, at the center portion of the console 19 or the instrument panel 46 above the center vent blowoff port 105.

As described above, there is provided the air conditioner for the vehicle comprising the passenger compartment 2 of the vehicle, the rear bulkhead 9 separating the rear portion of the passenger compartment 2, the rear cowl portion 10 disposed above the rear bulkhead 9, and the rear air conditioning unit 12 disposed behind the rear bulkhead 9, the rear air conditioning unit 12 taking in the inside-and-outside air for air conditioning via the rear cowl portion 10 and blowing off the conditioned air into the passenger compartment 2 of the vehicle.

According to the above-mentioned structure, since a layout of an air conditioning unit disposed at the front side of the vehicle is omitted, the vehicle engine 5 as a heavy article can be located at the center side of the vehicle and the yaw inertia moment of the vehicle can be reduced, thereby improving the maneuverability and stability of the vehicle and the dynamic performance of the vehicle. Namely, compatibleness of the center layout of the engine 5 and a layout of the rear air conditioning unit 12 can be provided.

Further, since the rear air conditioning unit 12 takes in the inside-and-outside air for air conditioning via the rear cowl portion 10 and blows off the conditioned air into the passenger compartment 2 of the vehicle, the compatibleness of the layout of the rear air conditioning unit 12 and the induction of the inside-and-outside air can be provided.

Further, the engine room 1 in which the engine 5 of the vehicle is disposed is formed before the passenger compartment 2 of the vehicle. Accordingly, a compact vehicle with a front engine can be provided.

Further, the upper part of the passenger compartment 2 is covered by the roof 4 capable of opening. Accordingly, a simple structure of the air conditioner for a so-called open car can be provided.

Additionally, there are provided the inside-and-outside air induction port 62 formed on the upper side of the rear cowl portion 10 and the aero-board 64 attached near the inside-and-outside air induction port 62, wherein the aero-board 64 is attached so as to change its position and the positional change of the aero-board 64 provides the induction switching of the inside-and-outside air for air conditioning. Accordingly, a proper switching between the inside-air induction and the outside-air induction can be attained by changing the position of the aero-board 64.

Further, there is provided the outside-air induction passage 73 which leads to the rear cowl portion 10 and opens to the outside of the vehicle through the vehicle outside wall (see the rear fender panel 7). Accordingly, the induction of the outside air through the vehicle outside wall (see the rear fender panel 7) can be ensured.

Further, there is provided the blowoff port 79 (for example, the blowoff port for blowing off the conditioned air to the neck portion of the passenger sitting on the seat 22) for blowing off the conditioned air from the rear air conditioning unit 12, which is formed on the side of the rear bulkhead 9 which is located toward the inside of the passenger compartment 2 of the vehicle. Accordingly, the distance between the rear air conditioning unit 12 and the blowoff port 79 can be made short, thereby reducing a passage length between them.

Additionally, the seat 22 of the vehicle is disposed before and close to the rear bulkhead 9 in the passenger compartment 2 of the vehicle, and the seat has the blowoff ports 82, 82A, 82B formed thereon for blowing off the conditioned air from the rear air conditioning unit 12. Accordingly, comfortable air conditioning can be attained by the conditioned air from the blowoff ports 82, 82A, 82B formed on the seat 22.

Further, the above-mentioned blowoff ports 82, 82A are located so as to blow off the conditioned air toward the back portion of the passenger sitting on the seat 22. Accordingly, since the proper control of air conditioning at the back portion of the passenger is provided, comfortable air conditioning can be attained.

Also, the blowoff ports 82, 82B on the seat are located so as to blow off the conditioned air toward the lumbar portion of the passenger sitting on the seat 22. Accordingly, since the proper control of air conditioning at the lumber portion of the passenger is provided, comfortable air conditioning can be attained.

Further, there is provided the tunnel portion 16 extending forward of the vehicle from the lower portion of the rear bulkhead 9, and the tunnel portion 16 has the blowoff port 87 formed thereon for blowing off the conditioned air from the rear air conditioning unit 12 toward the thigh portion of the passenger. Accordingly, since the proper control of air conditioning at the thigh portion of the passenger is provided with utilizing the tunnel portion 16, comfortable air conditioning can be attained.

Further, there is provided the tunnel portion 16 extending forward of the vehicle from the lower portion of the rear bulkhead 9, and the tunnel portion 16 has the blowoff port 88 formed thereon for blowing off the conditioned air from the rear air conditioning unit 12 toward the foot portion of the passenger. Accordingly, since the proper control of air conditioning at the foot portion of the passenger is provided with utilizing the tunnel portion 16, comfortable air conditioning can be attained.

Additionally, there is provided the upper tunnel member 17 above the tunnel portion 16 which forms the passage having the closed cross section 17A with the tunnel portion 16, and the air conditioning duct 86 for the conditioned air from the rear air conditioning unit 12 is formed in the closed cross section 17A. Accordingly, the air conditioning duct 86 can be provided properly by utilizing the closed cross section 17A between the tunnel portion 16 and the upper tunnel member 17 formed to increase rigidity of the vehicle floor and the vehicle body.

Also, the rear air conditioning unit 12 takes in at least the inside air of the passenger compartment 2, conditions the took-in air, and blows off the conditioned air into the passenger compartment 2, and there is further provided the front natural ventilation unit 102 which is disposed before the passenger compartment 2, takes in the outside air of the vehicle, and blows off the took-in air into the passenger compartment 2. Accordingly, the rear air conditioning and the natural ventilation can made compatible. Also, since the front natural ventilation unit 102 is provided before the passenger compartment 2, the move-back layout of the engine 5 and the function of air conditioning can be made compatible.

Namely, the front natural ventilation unit 102, unlike a normal front air conditioning unit, does not need any evaporator, heater core, funs or the like, and just has a structure to take in the outside air and blow off it. Accordingly, the move-back layout of the engine 5 and the function of the natural ventilation can be made compatible.

Further, there is provided air conditioning control means (see the air conditioning control portion 106) for cooperatively controlling the rear air conditioning unit 12 and the front natural ventilation unit 102. Accordingly, since the rear air conditioning unit 12 and the front natural ventilation unit 102 are controlled cooperatively by the air conditioning control means (see the air conditioning control portion 106), utility of controlling can be improved without controlling them separately.

Also, there is provided the tunnel portion 16 extending forward of the vehicle from the lower portion of the rear bulkhead 9, and the tunnel portion 16 has the blowoff ports 107, 108 formed thereon for blowing off the outside air of the vehicle from the front natural ventilation unit 102. Accordingly, the comfortable feeling by the outside air during the vehicle running can be provided to the passenger by utilizing the tunnel portion 16. Especially, the ventilation by this outside air (natural wind) can be enhanced for the passenger in the open car.

Further, the rear air conditioning unit 12 is disposed between the rear bulkhead 9 and the trunk room 13 which is disposed behind the rear bulkhead 9, and there is further provided the trunk-room cooling-air passage (see the duct 92) for taking in the cooling air from the rear air conditioning unit 12 and providing the cooling air into the trunk room 13 to cool the inside of the trunk room 13. Accordingly, since the rear air conditioning unit 12 is disposed between the rear bulkhead 9 and the trunk room 13 behind the rear bulkhead 9 and the trunk room 13 is cooled by the cooling air from the rear air conditioning unit 12, forming the trunk room 13 and providing the rear air conditioning unit 12 can be made compatible, and also the trunk room 13 can be cooled by the rear air conditioning unit 12 of the air conditioner for the vehicle, without providing any additional cooling devices for the trunk room 13.

Further, the trunk room 13 is divided into plural load compartments 13A, 13B, and the cooling air is introduced into at least one of the load compartments 13a, 13B to constitute it as the cooler box 91. Accordingly, the cooler box 91 can be cooled certainly and efficiently.

Also, there is provided the suspension damper 93 for suspending the rear wheel 48 of the vehicle close to the trunk room 13, and the suspension damper 93 is cooled by the cooling air from the rear air conditioning unit 12. Accordingly, since the cooling air of the rear air conditioning unit 12 cools the suspension damper 93, durability of the suspension damper 96 can be prevented from deteriorating and the function of the damper 93 can be also prevented from changing due to the heat. Particularly, heat deterioration of oil, packing, and rubbers in the damper 93 can be preferably prevented.

Additionally, there is provided the damper cooling-air passage (see the duct 96) for taking in the cooling air from the rear air conditioning unit 12 and providing the cooling air to the suspension damper 93. Accordingly, the damper can be cooled more certainly by the cooling air from the damper cooling-air passage (see the duct 96).

Further, there is provided the suspension damper 93 for suspending the rear wheel 48 of the vehicle behind the rear air conditioning unit 12, and the suspension damper 93 is cooled via the damper cooling-air passage (see the duct 96) which is formed for taking in the cooling air from the rear air conditioning unit 12 and providing the cooling air to the suspension damper 93. Accordingly, since the cooling air from the rear air conditioning unit 12 is led to the suspension damper 93 via the damper cooling-air passage (see the duct 96) and cools the damper 93 (particularly, oil, packing, and rubber in the damper 93), durability of the suspension damper 93 can be prevented from deteriorating and the function of the damper 93 can be also prevented from changing due to the heat.

With regard to the correspondence in structure between the present invention and the above-mentioned embodiment, the air conditioning unit of the invention corresponds to the rear air conditioning unit 12 of the embodiment, the outside wall of the vehicle body of the invention corresponds to the rear fender 71 of the embodiment, the tunnel member of the invention corresponds to the upper tunnel member 17 of the embodiment, the air conditioning control means of the invention corresponds to the air conditioning control portion 106 of the embodiment, the trunk room cooling-air passage of the invention corresponds to the duct 92 of the embodiment, and the damper cooling-air passage of the invention corresponds to the duct 96 of the embodiment, respectively.

However, the invention is not limited to this embodiment. Any other modifications may be applied within the scope of a sprit of the present invention.

1. An air conditioner for a vehicle comprising:
a passenger compartment of the vehicle;
a rear bulkhead separating a rear portion of said passenger compartment;
a rear cowl portion disposed above said rear bulkhead; and
a rear air conditioning unit disposed behind said rear bulkhead, the rear air conditioning unit taking in inside-and-outside air for air conditioning via said rear cowl portion and blowing off conditioned air into said passenger compartment of the vehicle.

2. The air conditioner for a vehicle of claim 1, wherein an engine room in which an engine of the vehicle is disposed is formed before said passenger compartment of the vehicle.

3. The air conditioner for a vehicle of claim 1, wherein an upper part of said passenger compartment is covered by a roof capable of opening.

4. The air conditioner for a vehicle of claim 3, further comprising an inside-and-outside air induction port formed on an upper side of said rear cowl portion and an aero-board attached near said inside-and-outside air induction port, wherein said aero-board is attached so as to change its position and a positional change of said aero-board provides an induction switching of said inside-and-outside air for air conditioning.

5. The air conditioner for a vehicle of claim 1, further comprising an outside-air induction passage which leads to said rear cowl portion and opens to an outside of the vehicle through a vehicle outside wall.

6. The air conditioner for a vehicle of claim 1, further comprising a blowoff port for blowing off the conditioned air from said rear air conditioning unit, which is formed on a side of said rear bulkhead which is located toward an inside of said passenger compartment of the vehicle.

7. The air conditioner for a vehicle of claim 1, wherein a seat of the vehicle is disposed before and close to said rear bulkhead in the passenger compartment of the vehicle, and the seat has a blowoff port formed thereon for blowing off the conditioned air from said rear air conditioning unit.

8. The air conditioner for a vehicle of claim 7, wherein said blowoff port on the seat is located so as to blow off the conditioned air toward a back portion of a passenger sitting on the seat.

9. The air conditioner for a vehicle of claim 7, wherein said blowoff port on the seat is located so as to blow off the conditioned air toward a lumbar portion of a passenger sitting on the seat.

10. The air conditioner for a vehicle of claim 1, wherein there is provided a tunnel portion extending forward of the vehicle from a lower portion of said rear bulkhead, and said tunnel portion has a blowoff port formed thereon for blowing off the conditioned air from said rear air conditioning unit toward a thigh portion of a passenger.

11. The air conditioner for a vehicle of claim 1, wherein there is provided a tunnel portion extending forward of the vehicle from a lower portion of said rear bulkhead, and said tunnel portion has a blowoff port formed thereon for blowing off the conditioned air from said rear air conditioning unit toward a foot portion of a passenger.

12. The air conditioner for a vehicle of claim 10, wherein there is provided a tunnel member above said tunnel portion which forms a passage having a closed cross section with the tunnel portion, and an air conditioning duct for the conditioned air from said rear air conditioning unit is formed in said passage having the closed cross section.

13. The air conditioner for a vehicle of claim 1, wherein said rear air conditioning unit takes in at least inside air of the passenger compartment, conditions the took-in air, and blows off the conditioned air into the passenger compartment, and there is further provided a front natural ventilation unit which is disposed before the passenger compartment, takes in outside air of the vehicle, and blows off the took-in air into the passenger compartment.

14. The air conditioner for a vehicle of claim 13, further comprising air conditioning control means for cooperatively controlling said rear air conditioning unit and said front natural ventilation unit.

15. The air conditioner for a vehicle of claim 13, wherein there is provided a tunnel portion extending forward of the vehicle from a lower portion of said rear bulkhead, and said tunnel portion has a blowoff port formed thereon for blowing off the outside air of the vehicle from said front natural ventilation unit.

16. The air conditioner for a vehicle of claim 1, wherein said rear air conditioning unit is disposed between said rear bulkhead and a trunk room which is disposed behind the rear bulkhead, and there is further provided a trunk-room cooling-air passage for taking in cooling air from the rear air conditioning unit and providing the cooling air into said trunk room to cool an inside of the trunk room.

17. The air conditioner for a vehicle of claim 16, wherein said trunk room is divided into plural load compartments, and said cooling air is introduced into at least one of the load compartments to constitute it as a cooler box.

18. The air conditioner for a vehicle of claim 16, wherein there is provided a suspension damper for suspending a rear wheel of the vehicle close to said trunk room, and the suspension damper is cooled by said cooling air from the rear air conditioning unit.

19. The air conditioner for a vehicle of claim 18, wherein there is further provided a damper cooling-air passage for taking in said cooling air from the rear air conditioning unit and providing the cooling air to said suspension damper.

20. The air conditioner for a vehicle of claim 1, wherein there is provided a suspension damper for suspending a rear wheel of the vehicle behind said rear air conditioning unit, and the suspension damper is cooled via a damper cooling-air passage which is formed for taking in a cooling air from said rear air conditioning unit and providing the cooling air to the suspension damper.
